(19) United States
(12) Patent Application Publication
(10) Pub. No.: US 2026/0096710 A1
(43) Pub. Date: Apr. 9, 2026

(54) METHOD FOR PROVIDING THREE-DIMENSIONAL MAP FOR CLEANING ROBOT, AND DEVICE THEREFOR

(71) Applicant: Samsung Electronics Co., Ltd., Suwon-si (KR)

(72) Inventors: Sooyoung CHOI, Suwon-si (KR); Soyoung YUN, Suwon-si (KR); Miyoung LEE, Suwon-si (KR)

(21) Appl. No.: 19/418,113

(22) Filed: Dec. 12, 2025

Related U.S. Application Data
(63) Continuation of application No. PCT/KR2024/004156, filed on Apr. 1, 2024.

(30) Foreign Application Priority Data
Sep. 15, 2023 (KR) 10-2023-0123325
Jun. 15, 2023 (KR) 10-2023-0077065

(51) Int. Cl. A47L 11/40; A47L 9/00; A47L 9/28

(52) U.S. Cl. CPC A47L 11/4061; A47L 9/009; A47L 9/2852; A47L 11/4011; A47L 2201/04

(57) ABSTRACT

A device for providing a map of a cleaning area and a method of controlling the device are provided. The device includes a display, a communication module, at least one memory, including one or more storage media, storing instructions, and at least one processor, wherein the instructions, when executed by the at least one processor individually or collectively, cause the device to display, through the display, a three-dimensional map including a wall and an object of a cleaning space where a cleaning robot is located, based on receiving a user input for selecting the object obscured by the wall as a cleaning area of the cleaning robot, change the wall such that the object becomes visible, and transmit, to the cleaning robot, through the communication module, location information of the object and information about a cleaning function set for the object.

### CROSS-REFERENCE TO RELATED APPLICATIONS

This application is a continuation application, claiming priority under 35 U.S.C. § 365(c), of an International application No. PCT/KR2024/004156, filed on April 1, 2024, which is based on and claims the benefit of a Korean patent application number 10-2023-0077065, filed on June 15, 2023, in the Korean Intellectual Property Office, and of a Korean patent application number 10-2023-0123325, filed on September 15, 2023, in the Korean Intellectual Property Office, the disclosure of each of which is incorporated by reference herein in its entirety.

### BACKGROUND

### 1. Field

The disclosure relates to a device for providing a three-dimensional map for a cleaning robot, a method of controlling the device, and a computer-readable recording medium storing a computer program for performing the method of controlling the device.

### 2. Description of Related Art

A cleaning robot may move autonomously and suck up dust from a floor, or suck up the dust together with mopping the floor. The cleaning robot may generate a map of a cleaning area by using a location recognition sensor while traveling. The cleaning robot may also transmit information about the generated map to a user device through a server. With the recent advancement of cleaning robot technology, the cleaning robot may generate a three-dimensional map of a cleaning area.

The user device may display a map for the cleaning robot. The user device may also set an area by using the map and receive a user input for setting a function of the cleaning robot for the set area. In addition, the user device may provide a cleaning result on the map.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a device for providing a three-dimensional map for a cleaning robot, a method of controlling the device, and a computer-readable recording medium storing a computer program for performing the method of controlling the device.

Additional aspects will be set forth in part in the description which follows and, in part, will be apparent from the description, or may be learned by practice of the presented embodiments.

In accordance with an aspect of the disclosure, a device for providing a map of a cleaning area of a cleaning robot is provided. The device includes a display, a communication module, at least one memory, including one or more storage media, storing one or more instructions, and at least one processor, wherein the instructions, when executed by the at least one processor individually or collectively, cause the device to display, through the display, a three-dimensional map including a wall and an object of a cleaning space where the cleaning robot is located, based on receiving a user input for selecting the object obscured by the wall as the cleaning area of the cleaning robot, change the wall such that the object becomes visible and transmit, to the cleaning robot, through the communication module, location information of the object and information about a cleaning function set for the object.

In accordance with another aspect of the disclosure, a method, performed by a device, of providing a map of a cleaning area of a cleaning robot is provided. The method includes displaying a three-dimensional map including a wall and an object of a cleaning space where the cleaning robot is located, based on receiving a user input for selecting the object obscured by the wall as the cleaning area of the cleaning robot, changing the wall such that the object becomes visible, and transmitting, to the cleaning robot, location information of the object and information about a cleaning function set for the object.

In accordance with another aspect of the disclosure, one or more non-transitory computer-readable storage media storing one or more computer programs including computer-executable instructions that, when executed by one or more processors of a device, of providing a map of a cleaning area of a cleaning robot, individually or collectively, cause the device to perform operations are provided. The operations include displaying a three-dimensional map including a wall and an object of a cleaning space where the cleaning robot is located, based on receiving a user input for selecting the object obscured by the wall as the cleaning area of the cleaning robot, changing the wall such that the object becomes visible, and transmitting, to the cleaning robot, location information of the object and information about a cleaning function set for the object.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a method, performed by a device, of providing a three-dimensional map, according to an embodiment of the disclosure;

FIG. 2 illustrates block diagrams of a device, a server, and a cleaning robot, according to an embodiment of the disclosure;

FIG. 3 is a flowchart of a method, performed by a device, of providing a three-dimensional map, according to an embodiment of the disclosure;

FIG. 4 illustrates a method, performed by a device, of providing a user interface for setting a cleaning spot in a three-dimensional map, according to an embodiment of the disclosure;

FIG. 5 illustrates a method, performed by a device, of providing a user interface for setting a vicinity of a piece of furniture as a cleaning spot in a three-dimensional map, according to an embodiment of the disclosure;

FIG. 6A is a flowchart of a method, performed by a device, of changing only a wall in a vicinity of a selected object, according to an embodiment of the disclosure;

FIG. 6B illustrates a method, performed by a device, of determining a method of displaying a wall when an object in a three-dimensional map is selected, according to an embodiment of the disclosure;

FIG. 7 illustrates a method, performed by a device, of lowering only a wall obscuring a selected object in a three-dimensional map, according to an embodiment of the disclosure;

FIG. 8 illustrates a method, performed by a device, of changing a wall obscuring a selected object in a three-dimensional map to be transparent, according to an embodiment of the disclosure;

FIG. 9 illustrates a method, performed by a device, of changing a state of one of an inner wall and an outer wall in a three-dimensional map, according to an embodiment of the disclosure;

FIG. 10 illustrates a method, performed by a device, of indicating, on a three-dimensional map, an obstacle detected during travel of a cleaning robot, according to an embodiment of the disclosure;

FIG. 11 illustrates a method, performed by a device, of obtaining a default value of a default value of a height of a wall or an opacity of a wall in a three-dimensional map, according to an embodiment of the disclosure;

FIG. 12 illustrates a method, performed by a device, of indicating a current time of a cleaning robot on a three-dimensional map, according to an embodiment of the disclosure;

FIG. 13 illustrates a method, performed by a device, of indicating a current time of a cleaning robot on a three-dimensional map, according to an embodiment of the disclosure; and

FIG. 14 illustrates a block diagram of a device, according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Terms, such as "first" and "second" may be used to describe various elements, but the elements should not be limited by these terms. These terms are merely used to distinguish one element from another.

In addition, the terms used herein are merely used to describe certain embodiments and are not intended to be limiting of the disclosure. Throughout the specification, when a part is "connected" to another part, the part may not only be "directly connected" to the other part, but may also be "electrically connected" to the other part with another element in between. When a part "includes" a certain element, the part may further include another element instead of excluding the other element, unless otherwise stated.

Expressions, such as "in some embodiments" or "in an embodiment" used throughout the specification are not intended to indicate the same embodiment.

Embodiments of the disclosure provide a device for providing a three-dimensional map of a cleaning robot, and a method of controlling the same.

Embodiments of the disclosure provide a device for providing a user interface for adjusting the height of a wall or the opacity of a wall in a three-dimensional map, and a method of controlling the same.

Embodiments of the disclosure provide a device for providing information about a current time in a three-dimensional map, and a method of controlling the same.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth^{TM} chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

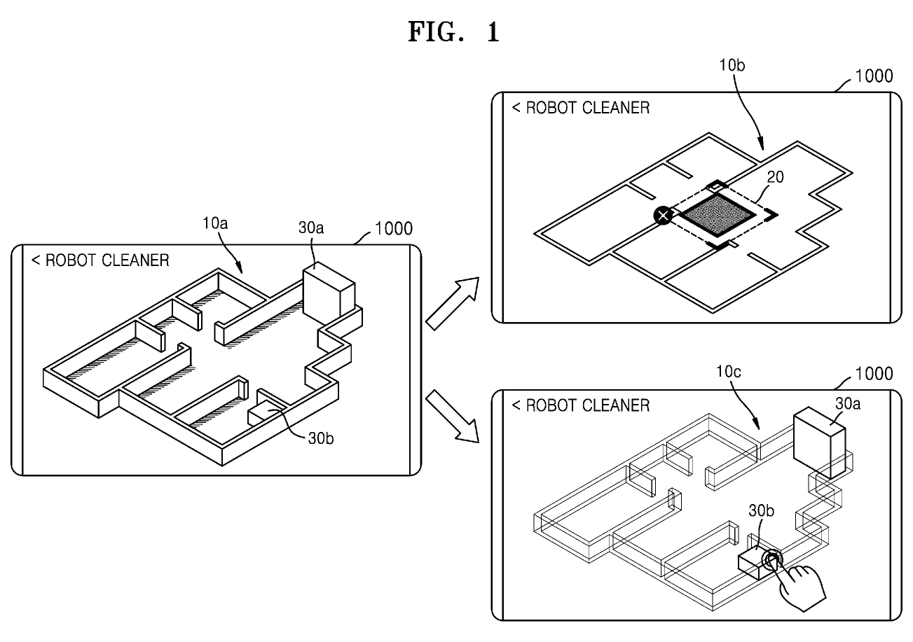

FIG. 1 illustrates a method, performed by a device, of providing a three-dimensional map, according to an embodiment of the disclosure.

Referring to FIG. 1, a device 1000 may provide a three-dimensional map of a cleaning space of a cleaning robot, and may provide a user interface for adjusting the height of a wall or the opacity of a wall in the three-dimensional map. The device 1000 may facilitate user interaction with an area obscured by a three-dimensional wall by adjusting the height of the wall or the opacity of the wall in the three-dimensional map.

Referring to the left diagram of FIG. 1, the device 1000 may display a three-dimensional map 10a for a cleaning robot. The three-dimensional map 10a may include a wall of a cleaning space a room, a home appliance or piece of furniture 30a or 30b placed in the cleaning space, or an obstacle.

According to an embodiment of the disclosure, based on receiving a user input for selecting an object that is obscured by the wall as a cleaning area of the cleaning robot, the device 1000 may lower the height of the wall such that the object becomes visible.

The object may be a room of the cleaning space, a portion of a floor of the cleaning space, a piece of furniture or home appliance located in the cleaning space, or an obstacle located in the cleaning space, but is not limited thereto.

For example, based on receiving a user input for selecting a menu for setting a cleaning spot, the device 1000 may lower the height of the wall to the floor, as shown in a three-dimensional map 10b on the upper right of FIG. 1. By lowering the height of the wall, the floor previously obscured by the wall may be easily viewed, and the device 1000 may display a user interface 20 for setting a cleaning spot on the three-dimensional map 10b where the floor is exposed for view.

According to an embodiment of the disclosure, based on receiving a user input for selecting the object that is obscured by the wall, the device 1000 may increase the opacity of the wall to that the object becomes visible.

For example, based on receiving a user input for selecting the piece of furniture 30b to intensively clean around the piece of furniture, the device 1000 may increase the opacity of the wall, as shown in a three-dimensional map 10c on the lower right of FIG. 1. By increasing the opacity of the wall, the piece of furniture 30b previously obscured by the wall may be easily viewed, and the user may easily select the piece of furniture 30b.

The device 1000 may transmit, to the cleaning robot, through a server, location information of the object and information about a cleaning function set for the object.

According to an embodiment of the disclosure, the device 1000 may indicate a current time of the cleaning robot on the three-dimensional map by changing the color of at least one of the wall or the floor in the three-dimensional map over time. For example, the device 1000 may provide information about the current time of the cleaning robot by displaying the three-dimensional map in dark tones at night.

According to an embodiment of the disclosure, the device 1000 may display the current time of the cleaning robot on the three-dimensional map by changing the length of a shadow of the wall in the three-dimensional map over time.

According to an embodiment of the disclosure, the device 1000 may receive a user input for setting a default value of the height of the wall or the opacity of the wall, and may display the three-dimensional map based on the default value. Accordingly, the user may generate a three-dimensional map of the desired shape.

According to an embodiment of the disclosure, when displaying, on the three-dimensional map, an obstacle detected during travel of the cleaning robot, the device 1000 may accurately indicate the location of the obstacle by increasing the opacity of a wall obscuring the obstacle.

According to an embodiment of the disclosure, the device 1000 may change the height or opacity of one of an inner wall and an outer wall in the three-dimensional map.

The three-dimensional map of the cleaning space may provide a more intuitive view of the cleaning space, and may facilitate user interaction with a space under a piece of furniture. Moreover, the three-dimensional map allows the user to intuitively identify a piece of furniture or home appliance through the three-dimensional shape of the piece of furniture or home appliance, even without the name of the piece of furniture or home appliance. However, the three-dimensional map has an issue in that it is difficult to identify an edge of the floor that is obscured by the wall or the location of a piece of furniture that is lower than the height of the wall. According to an embodiment of the disclosure, by adjusting the height or opacity of the wall according to a setting menu or object selection, the device 1000 may facilitate viewing of the location of the floor or piece of furniture that is obscured by the wall, without requiring the user to zoom in or out, change the viewing angle, or rotate the three-dimensional map.

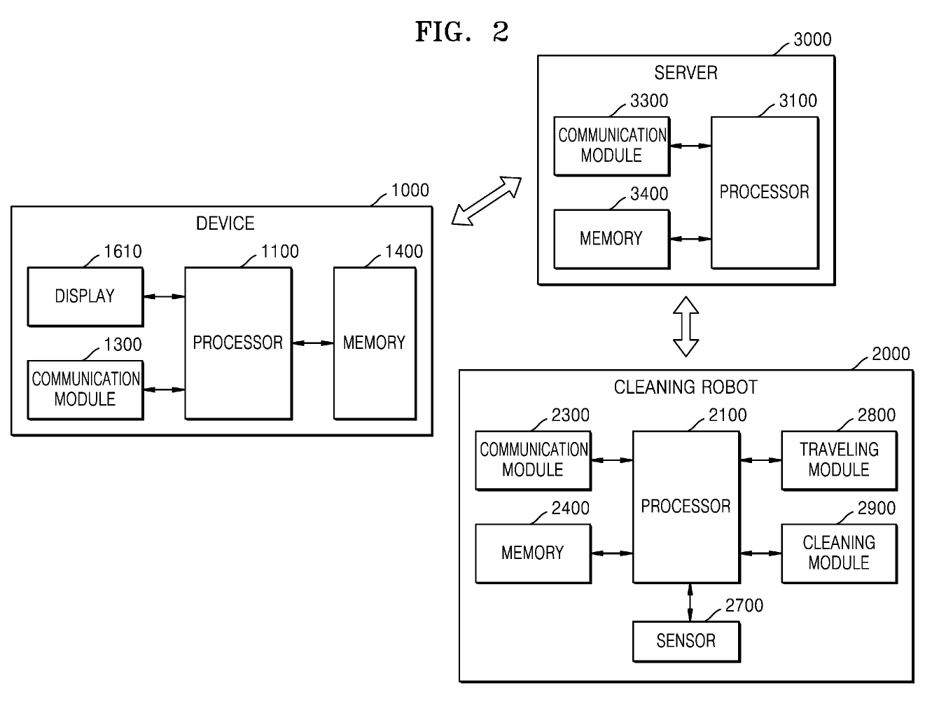

FIG. 2 illustrates block diagrams of a device, a cleaning robot, and a server, according to an embodiment of the disclosure.

Referring to FIG. 2, the device 1000 may include a processor 1100, a communication module 1300, memory 1400, and a display 1610.

The processor 1100 may generally control the overall operation of the device 1000. The processor 1100 may control the communication module 1300 and the display 1610 by executing programs stored in the memory 1400.

The device 1000 may include a mobile device 1000, a refrigerator, a laptop, a desktop personal computer (PC), or a tablet PC, but is not limited thereto.

In addition, referring to FIG. 2, a cleaning robot 2000 may include a processor 2100, a communication module 2300, memory 2400, a sensor 2700, a traveling module 2800, and a cleaning module 2900.

The processor 2100 of the cleaning robot 2000 may generally control the overall operation of the cleaning robot 2000. The processor 2100 of the cleaning robot 2000 may control the sensor 2700, the communication module 2300, the traveling module 2800, and the cleaning module 2900 by executing programs stored in the memory 2400.

The cleaning robot 2000 may include a suction-type cleaning robot, a mopping-type cleaning robot, and a dual-purpose cleaning robot for both suction and mopping, but is not limited thereto.

The communication module 2300 may transmit and receive information according to a protocol with an external device or a server 3000, under control by the processor 2100. The external device may include, for example, a charging station or the device 1000, but is not limited thereto. The communication module 2300 may communicate with the external device through at least one wired or wireless communication network.

The communication module 2300 may include at least one of a short-range communication module or a long-range communication module, or a combination thereof. The communication module 2300 may include at least one antenna for wirelessly communicating with another device.

The short-range communication module may include at least one communication module for performing communication according to a communication standard, such as Bluetooth, Wi-Fi, Bluetooth low energy (BLE), near field communication (NFC)/radio frequency identification (RFID), Wi-Fi Direct, ultra-wideband (UWB), or ZIGBEE. In addition, the long-range communication module may include a mobile communication module for performing communication according to a communication standard, such as third generation (3G), fourth generation (4G), fifth generation (5G), and/or sixth generation (6G). Moreover, the communication module 2300 may include an infrared communication module.

The cleaning module 2900 may include at least one of a suction unit and a mopping unit. The suction unit may collect dust on a floor while sucking in air. The suction unit may include a rotating brush, a rotating brush motor, a suction motor, an air intake, a filter, a dust collection chamber, and an air exhaust, but is not limited thereto.

The traveling module 2800 moves a main body of the cleaning robot 2000. The traveling module 2800 is driven according to a control signal set by the processor 2100. The processor 2100 sets a travel path, generates a control signal to cause the cleaning robot 2000 to move along the travel path, and outputs the control signal to the traveling module 2800. The traveling module 2800 may include two wheels installed on both sides of the front, two wheels installed on both sides of the rear, a motor for rotationally driving of each of the two rear wheels, and a timing belt installed to transmit power generated from the rear wheels to the front wheels, but is not limited thereto.

The sensor 2700 may include a plurality of sensors configured to detect information about the environment surrounding the cleaning robot 2000. For example, the sensor 2700 may include a fall prevention sensor, an ultrasonic sensor, a motion sensor, a camera, and a location recognition sensor, but is not limited thereto.

The cleaning robot 2000 may further include, in addition to the processor 2100, the communication module 2300, the memory 2400, the sensor 2700, the traveling module 2800, and the cleaning module 2900, an input interface for receiving a user input and an output module for outputting information.

The cleaning robot 2000 may generate a map of the environment surrounding the cleaning robot 2000 by using the location recognition sensor (e.g., a light detection and ranging (LiDAR) sensor) and the camera while traveling. The cleaning robot 2000 may obtain two-dimensional map information and three-dimensional map information by recognizing a floor and a wall of a cleaning space, as well as a home appliance, a piece of furniture, and an obstacle that are placed in the cleaning space. Also, the cleaning robot 2000 may transmit the two-dimensional map information and the three-dimensional map information to the server 3000 through the communication module 2300.

Also, referring to FIG. 2, the server 3000 may include a processor 3100, a communication module 3300, and memory 3400.

The processor 3100 of the server 3000 may generally control the overall operation of the server 3000. The processor 2100 of the server 3000 may control the communication module 3300 by executing programs stored in the memory 3400. The server 3000 may store identification information of the device 1000 and identification information of the cleaning robot 2000 in correspondence with a user account.

The communication module 3300 of the server 3000 may transmit and receive information according to a protocol with the cleaning robot 2000, the device 1000, and an external server 3000, under control by the processor 3100.

The server 3000 may receive two-dimensional map information and three-dimensional map information from the cleaning robot 2000 through the communication module 3300. Also, the server 3000 may receive status information, cleaning progress status information, and cleaning result information of the cleaning robot 2000 from the cleaning robot 2000, and may transmit the received information to the device 1000. For example, based on a user account, the server 3000 may receive information about an obstacle detected during travel of the cleaning robot 2000 from the cleaning robot 2000, and may transmit the received information about the obstacle to the device 1000.

The device 1000 may control the display 1610 to display information received from the server 3000. For example, the device 1000 may display a three-dimensional map of the cleaning space where the cleaning robot 2000 is located.

Also, the server 3000 may receive a control command for the cleaning robot 2000 from the device 1000 through the communication module 3300, and may transmit the received control command to the cleaning robot 2000. For example, based on a user account, the server 3000 may receive location information of an object selected by the user from the device 1000 and information about a cleaning function set for the object. The cleaning robot 2000 may clean and travel by controlling the traveling module 2800 and the cleaning module 2900 according to the received information.

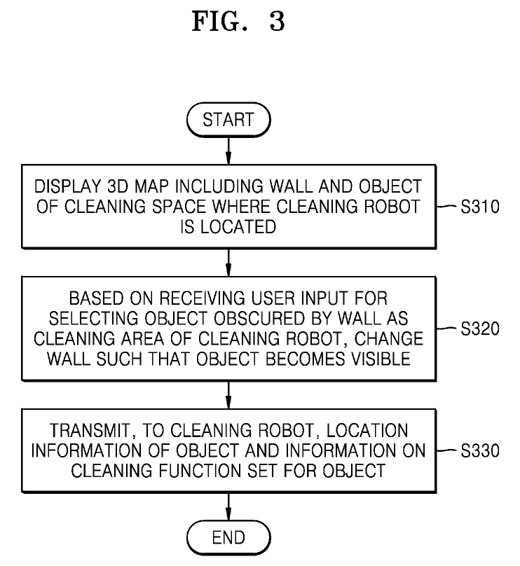

FIG. 3 is a flowchart of a method, performed by a device, of providing a three-dimensional map, according to an embodiment of the disclosure.

Referring to FIG. 3, in operation S310, the device 1000 may display a three-dimensional map including a wall and an object of a cleaning space where the cleaning robot 2000 is located.

The object may be a room of the cleaning space, a portion of a floor of the cleaning space, a piece of furniture or home appliance located in the cleaning space, or an obstacle located in the cleaning space, but is not limited thereto.

The device 1000 may receive, from the server 3000, information about a three-dimensional map indicating a wall and an object located in a cleaning space, and may display a three-dimensional map of the cleaning space based on the received information. For example, the device 1000 may receive, from the server 3000, location information of the wall and the object of the cleaning space and identification information of the object, may generate a three-dimensional map based on the received information, and may display the generated three-dimensional map.

The device 1000 may display the three-dimensional map of the cleaning space based on a user input for selecting an application for the cleaning robot 2000. Also, the device 1000 may display the three-dimensional map of the cleaning space based on a user input for selecting a menu for setting a cleaning function of the cleaning robot 2000. Also, the device 1000 may display the three-dimensional map of the cleaning space based on a user input for selecting a push notification message for the cleaning robot 2000.

When displaying the three-dimensional map, the device 1000 may display, based on a default height of the wall, the three-dimensional map having a default height. Also, when displaying the three-dimensional map, the device 1000 may display, based on a default opacity of the wall, the three-dimensional map having a default opacity. The default height and the default opacity may be determined by a user's choice.

In operation S320, based on receiving a user input for selecting the object that is obscured by the wall as a cleaning area of the cleaning robot 2000, the device 1000 may change the wall such that the object becomes visible.

In the three-dimensional map, the object may be partially or completely obscured by the wall. For example, when the object is the floor, a portion thereof close to the wall may be obscured by the wall. Also, for example, when the object is a home appliance or piece of furniture, the home appliance or piece of furniture close to the wall may be partially or completely obscured by the wall. In this case, when the height of an image of the home appliance or piece of furniture in the three-dimensional map is lower than the height of the wall, the home appliance or piece of furniture may be mostly obscured by the wall.

The user input for selecting the object that is obscured by the wall as a cleaning area may include an user input for selecting the object itself as a cleaning area. Also, the user input for selecting the object that is obscured by the wall as a cleaning area may include a user input for selecting a menu for setting a cleaning spot.

The device 1000 may change the wall such that the object obscured by the wall becomes visible.

According to an embodiment of the disclosure, the device 1000 may lower the height of the wall such that the object obscured by the wall becomes visible. For example, the device 1000 may lower the height of the wall to the floor. Also, for example, the device 1000 may lower the height of the wall to a predetermined height. Also, for example, the device 1000 may receive, through a user interface, a user input for adjusting the height of the wall.

According to an embodiment of the disclosure, the device 1000 may increase the opacity of the wall such that the object obscured by the wall becomes visible. For example, the device 1000 may change the opacity of the wall to a predetermined opacity. Also, for example, the device 1000 may receive, through a user interface, a user input for adjusting the opacity of the wall.

According to an embodiment of the disclosure, the device 1000 may change the height or opacity of a wall obscuring the object, from among an inner wall and an outer wall in the three-dimensional map.

In operation S330, the device 1000 may transmit, to the cleaning robot 2000, location information of the object and information about a cleaning function set for the object.

The device 1000 may receive a user input for selecting the object. For example, the device 1000 may receive a user input for selecting a room, a portion of the floor, or a piece of furniture. The cleaning function set for the object may be room cleaning, cleaning a portion of the floor, or intensive cleaning around a piece of furniture.

The device 1000 may transmit, to the cleaning robot 2000 through the server 3000, the location information of the object and the information about the cleaning function set for the object. The cleaning robot 2000 may perform, based on the received information, a cleaning function set for the selected object. For example, the cleaning robot 2000 may clean a selected room. Also, the cleaning robot 2000 may clean a selected portion of the floor. Also, for example, the cleaning robot 2000 may intensively clean around a selected piece of furniture.

According to an embodiment of the disclosure, the device 1000 may display the three-dimensional map including an obstacle detected during travel of the cleaning robot 2000, and may accurately indicate the location of the obstacle by increasing the opacity of a wall obscuring the obstacle.

According to an embodiment of the disclosure, the device may indicate a current time of the cleaning robot on the three-dimensional map by changing the color of at least one of the wall or the floor in the three-dimensional map over time.

According to an embodiment of the disclosure, the device may display the current time of the cleaning robot on the three-dimensional map by changing the length of a shadow of the wall in the three-dimensional map over time.

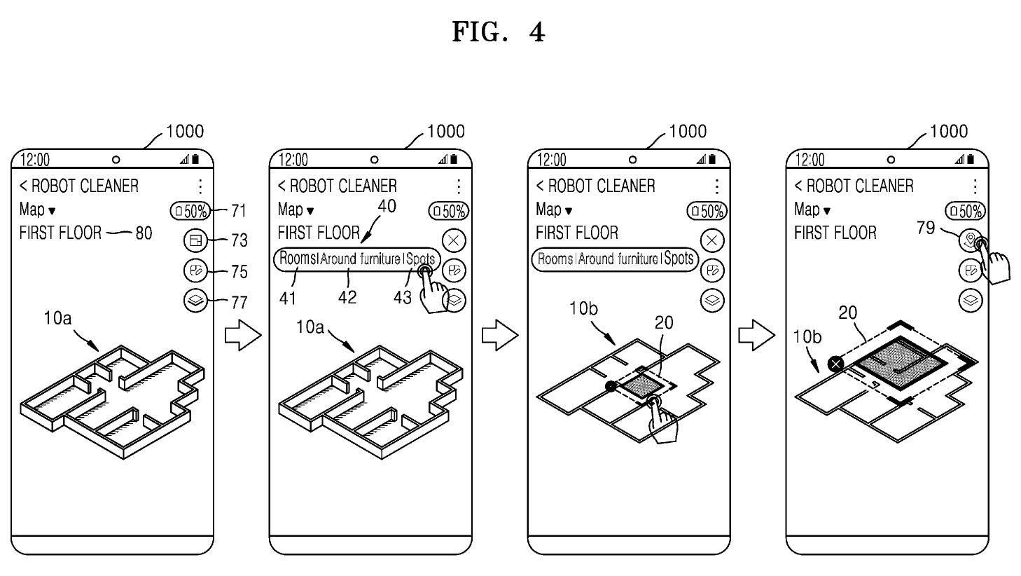

FIG. 4 illustrates a method, performed by a device, of providing a user interface for setting a cleaning spot in a three-dimensional map, according to an embodiment of the disclosure.

Referring to FIG. 4, based on receiving a user input for selecting a menu 73 for setting a cleaning spot in a three-dimensional map, the device 1000 may change the three-dimensional map 10a into the map 10b where the height of the wall is lowered to the floor.

Referring to the first diagram of FIG. 4, based on receiving a user input for selecting an application for the cleaning robot 2000, the device 1000 may display the three-dimensional map 10a of a cleaning space of the cleaning robot 2000. For example, the device 1000 may receive the three-dimensional map from the server 3000 based on a user account, and may display the received three-dimensional map 10a.

Also, the device 1000 may display, together with the three-dimensional map 10a, identification information 80 of the cleaning space indicated by the three-dimensional map 10a and charging status information 71 of the cleaning robot 2000. Also, the device 1000 may display the menu 73 for setting a cleaning spot, a menu 75 for editing a map, and a menu 77 for changing the three-dimensional map 10a into a two-dimensional map.

Based on receiving a user input for selecting the menu 73 for setting a cleaning spot, the device 1000 may display a submenu list 40 of the menu 73 for setting a cleaning spot, as shown in the second diagram of FIG. 4. The submenu list 40 of the menu 73 for setting a cleaning spot may include a submenu 41 for selecting a room, a submenu 42 for intensive cleaning around a piece of furniture or home appliance, and a submenu 43 for arbitrarily setting a cleaning spot.

Based on receiving a user input for selecting the submenu 43 for arbitrarily setting a cleaning spot, the device 1000 may change the three-dimensional map 10a into the map 10b that does not include a wall, as shown in the third diagram of FIG. 4. According to an embodiment of the disclosure, the map 10b that does not include a wall may be a two-dimensional map.

Although not shown in FIG. 4, according to an embodiment of the disclosure, based on receiving a user input for selecting the submenu 43 for arbitrarily setting a cleaning spot, the device 1000 may maintain the outer shape of a wall in the three-dimensional map 10a, and may lower the height of the wall.

Although not shown in FIG. 4, the map 10b that does not include a wall may include room identification information at the location of each room. Also, the map 10b that does not include a wall may include a three-dimensional image indicating the location of a charging station. Also, the map 10b that does not include a wall may include a three-dimensional image indicating the locations of a piece of furniture and a home appliance.

The device 1000 may display the user interface 20 for randomly selecting the location of a cleaning spot on the map 10b that does not include a wall. By moving the location and adjusting the size of the user interface 20, the device 1000 may receive a user input for selecting detailed coordinates of a cleaning spot.

Referring to the fourth diagram of FIG. 4, based on receiving a user input of selecting a setting button 79 for setting, as an area to be cleaned, a cleaning spot selected through the user interface 20, the device 1000 may transmit, based on a user account, location information of the selected cleaning spot and information about a spot cleaning function to the server 3000.

The server 3000 may transmit the location information of the cleaning spot and the information about the spot cleaning function to the cleaning robot 2000, based on identification information of the cleaning robot 2000 corresponding to the user account. The cleaning robot 2000 may perform cleaning on the selected cleaning spot based on the location information of the cleaning spot and the information about the spot cleaning function received from the server 3000.

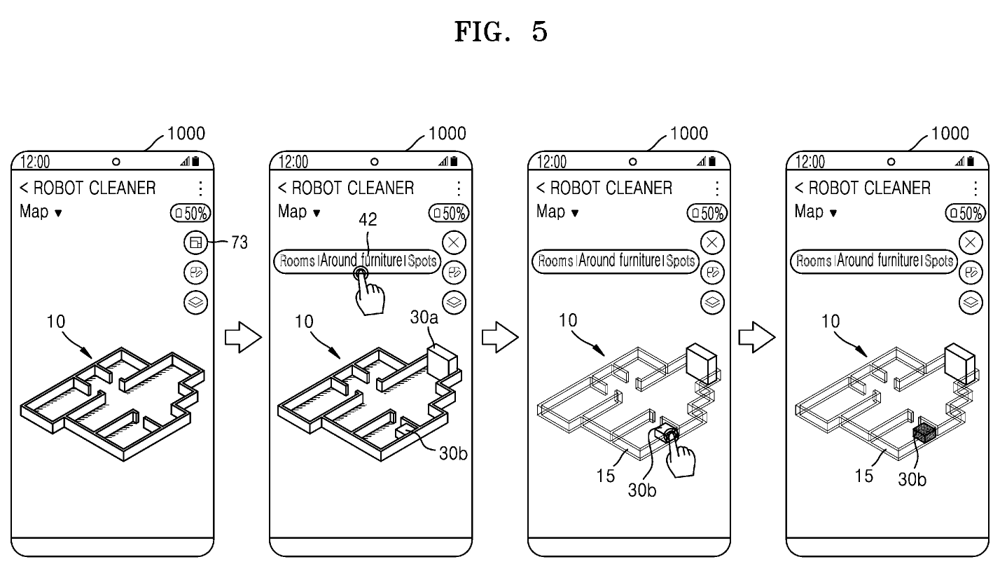

FIG. 5 illustrates a method, performed by a device, of providing a user interface for setting a vicinity of a piece of furniture as a cleaning spot in a three-dimensional map, according to an embodiment of the disclosure.

Referring to FIG. 5, based on receiving a user input for setting a vicinity of a piece of furniture as a cleaning spot in a three-dimensional map 10, the device 1000 may change a wall in the three-dimensional map 10 to be transparent.

Referring to the first diagram of FIG. 5, based on receiving a user input for selecting the menu 73 for setting a cleaning spot, the device 1000 may display a submenu list of the menu 73 for setting a cleaning spot, as shown in the second diagram of FIG. 5. Based on receiving a user input for selecting, from the submenu list, the submenu 42 for cleaning around a piece of furniture or home appliance, the device 1000 may display a three-dimensional image 30a or 30b of the piece of furniture or home appliance in the three-dimensional map 10.

The cleaning robot 2000 may recognize a piece of furniture or home appliance in a cleaning space while traveling. Also, the cleaning robot 2000 may store location information and identification information of the recognized piece of furniture or home appliance, and may transmit the same to the server 3000. The device 1000 may receive the location information and the identification information of the piece of furniture or home appliance from the server 3000, and, based on the received location information and identification information, may display an image 30a or 30b indicating the piece of furniture or home appliance in the three-dimensional map 10.

At this time, the image 30a or 30b indicating the piece of furniture or home appliance may be partially or completely obscured by the wall in the three-dimensional map 10. For example, the image 30b of a desk in FIG. 5 may be partially obscured by an outer wall such that only a portion thereof is visible.

As shown in the third diagram of FIG. 4, the device 1000 may receive a user input for selecting the piece of furniture or home appliance 30a or 30b in the three-dimensional map 10.

The device 1000 may change a wall 15 in the three-dimensional map 10 to be transparent, based on receiving a user input for selecting the desk 30b partially obscured by the wall. The device 1000 may change the wall 15 in the three-dimensional map 10 to be transparent, and may display the desk 30b such that the portion of the desk 30b previously obscured by the wall is visible. Also, as shown in the third diagram of FIG. 4, by changing the color of the desk 30b, the device 1000 may indicate that the desk 30b has been selected.

Accordingly, the user may accurately identify whether the selected piece of furniture or home appliance is a piece of furniture or home appliance the user intended to select.

Based on a user account, the device 1000 may transmit identification information and a cleaning control command of the selected piece of furniture or home appliance to the cleaning robot 2000 through the server 3000.

Based on the identification information and cleaning control command of the piece of furniture or home appliance, received from the server 3000, the cleaning robot 2000 may intensively clean a vicinity of the selected piece of furniture or home appliance.

According to an embodiment of the disclosure, based on selection of a piece of furniture or home appliance, wherein the height of an image of the piece of furniture or home appliance in the three-dimensional map is less than the height of the wall, the device 1000 may change the wall to be transparent.

According to an embodiment of the disclosure, based on selection of a vicinity of the wall, which includes the wall, the device 1000 may change the wall to be transparent.

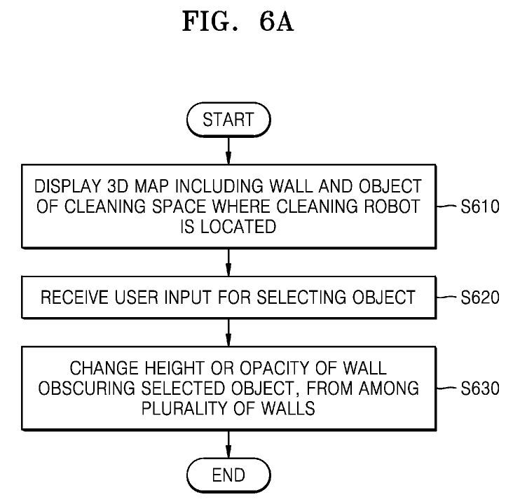

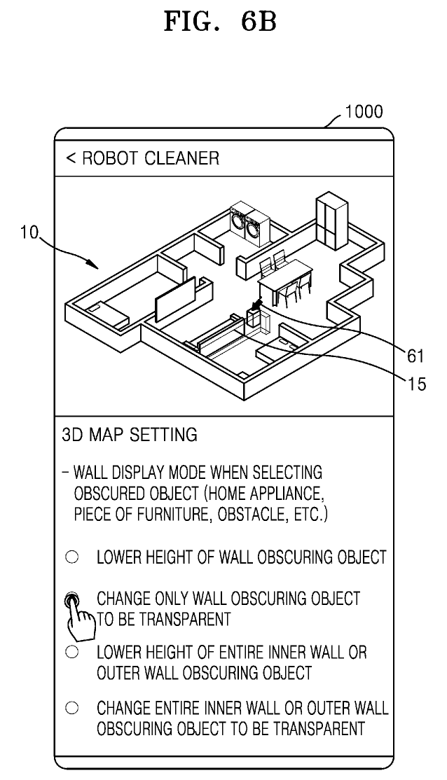

FIG. 6A is a flowchart of a method, performed by a device, of changing only a wall in a vicinity of a selected object, according to an embodiment of the disclosure.

Referring to FIG. 6A, in operation S610, the device 1000 may display a three-dimensional map including a wall and an object of a cleaning space where the cleaning robot 2000 is located.

According to an embodiment of the disclosure, the device 1000 may receive, from the server 3000, information about a three-dimensional map indicating a wall and an object located in a cleaning space, and may display a three-dimensional map of the cleaning space based on the received information.

In operation S620, the device 1000 may receive a user input for selecting the object.

The object may be a room of the cleaning space, a portion of a floor of the cleaning space, a piece of furniture or home appliance located in the cleaning space, or an obstacle located in the cleaning space, but is not limited thereto.

The device 1000 may receive a user input for selecting the object as an area to be cleaned. Also, the device 1000 may receive a user input for selecting the object to view a progress status of cleaning or a result of cleaning.

In operation S630, the device 1000 may change the height or opacity of a wall obscuring the selected object, from among a plurality of walls.

The device 1000 may determine the wall obscuring the selected object, from among the plurality of walls. For example, when the object is a room, the device 1000 may determine a wall obscuring the room based on the angle of the view of the three-dimensional map, from among walls surrounding the selected room. Also, for example, when the object is a piece of furniture or home appliance located in the cleaning space, the device 1000 may determine a wall obscuring the piece of furniture or home appliance, from among walls surrounding the selected piece of furniture or home appliance.

According to an embodiment of the disclosure, the device 1000 may lower the height of the wall obscuring the selected object. For example, the device 1000 may lower the height of the wall to be equal to or less than the height of an image of the selected object. Also, for example, the device 1000 may lower the wall obscuring the selected object to the floor.

According to an embodiment of the disclosure, the device 1000 may increase the opacity of the wall obscuring the selected object. For example, the device 1000 may increase the opacity of the wall obscuring the selected object to a predetermined opacity.

FIG. 6B illustrates a method, performed by a device, of determining a method of displaying a wall when an object in a three-dimensional map is selected, according to an embodiment of the disclosure.

Referring to FIG. 6B, the device 1000 may provide a user interface for setting a method of displaying a wall when an object covered by a wall in a three-dimensional map is selected.

For example, as shown in FIG. 6B, the user interface may include options for displaying the wall when the obscured object is selected, such as "Lower height of wall obscuring object", "Change only wall obscuring object to be transparent", "Lower height of entire inner wall or outer wall obscuring object", and "Change entire inner wall or outer wall obscuring object to be transparent".

Also, by changing the wall on the three-dimensional map 10 according to a selected option, the device 1000 may display a description of the option as an image. For example, based on receiving a user input for selecting the option "Change only wall obscuring object to be transparent", the device 1000 may change an image 61 indicating the target object on the three-dimensional map 10 and the wall 15 obscuring the object to be transparent.

Also, the device 1000 may store the selected option, based on receiving a user input for selecting the option. When executing an application for the cleaning robot 2000, based on receiving a user input for selecting the object on the three-dimensional map, the device 1000 may change a wall image according to the stored option. For example, based on storage of the option "Change only wall obscuring object to be transparent", the device 1000 may change only the wall obscuring the selected object to be transparent.

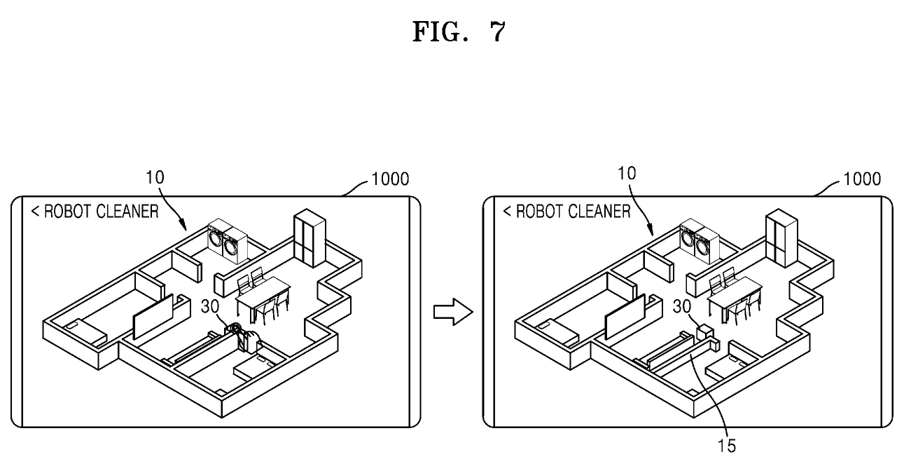

FIG. 7 illustrates a method, performed by a device, of lowering only a wall obscuring a selected object in a three-dimensional map, according to an embodiment of the disclosure.

Referring to FIG. 7, when the device 1000 receives a user input for selecting a home appliance or piece of furniture in the three-dimensional map 10, the device 1000 may determine a wall obscuring the selected home appliance or piece of furniture, from among walls in the three-dimensional map 10, and may lower the height of the wall obscuring the selected home appliance or piece of furniture.

As shown in FIG. 7, based on receiving a user input for selecting an air purifier image 30, the device 1000 may lower the height of the wall 15 obscuring the air purifier image 30, from among a plurality of walls in the three-dimensional map 10.

For example, the device 1000 may delete only the wall 15 obscuring the air purifier image 30. Also, for example, the device 1000 may lower the height of the wall 15 obscuring the air purifier image 30 to be lower than the height of the air purifier image 30.

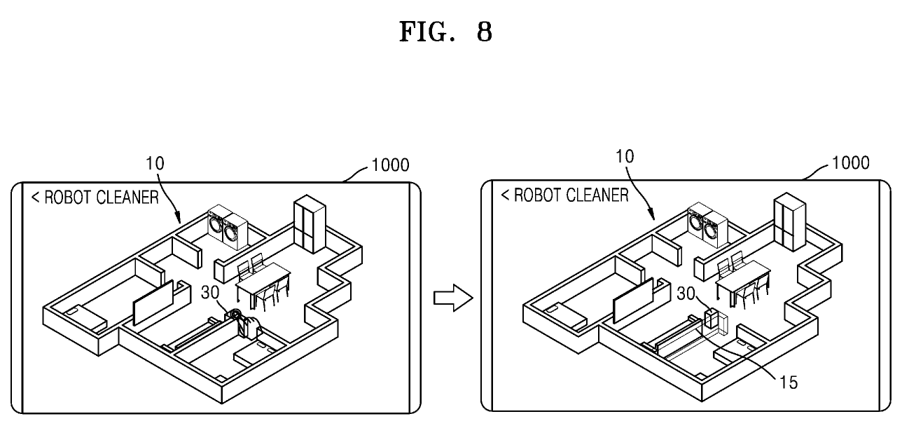

FIG. 8 illustrates a method, performed by a device, of changing a wall obscuring a selected object in a three-dimensional map to be transparent, according to an embodiment of the disclosure.

Referring to FIG. 8, when the device 1000 receives a user input for selecting a home appliance or piece of furniture in the three-dimensional map 10, the device 1000 may change a wall obscuring the selected home appliance or piece of furniture, from among the walls in the three-dimensional map 10, to be transparent.

As shown in FIG. 8, based on receiving a user input for selecting the air purifier image 30, the device 1000 may change the wall 15 obscuring the air purifier image 30, from among the plurality of walls in the three-dimensional map 10, to be transparent. For example, the device 1000 may change portions other than edges to be transparent such that only the outline of the wall 15 obscuring the air purifier image 30 may be identified.

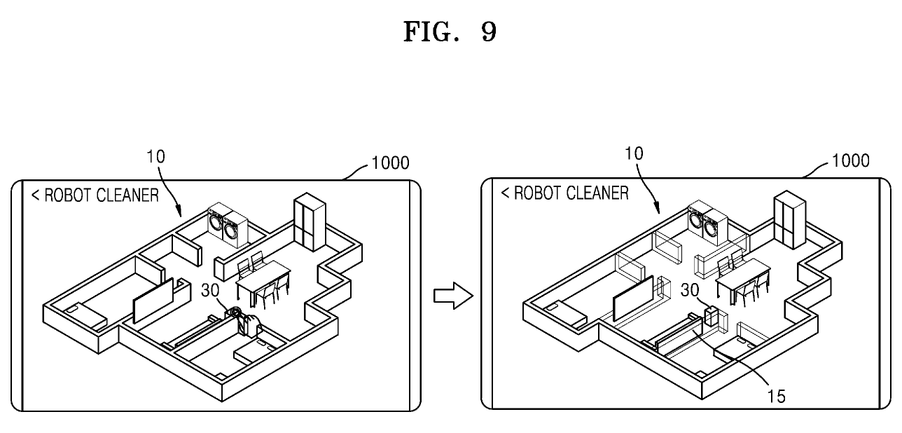

FIG. 9 illustrates a method, performed by a device, of changing a state of one of an inner wall and an outer wall in a three-dimensional map, according to an embodiment of the disclosure.

Referring to FIG. 9, based on a user input for selecting an object, the device 1000 may change one of the inner wall and the outer wall in the three-dimensional map. For example, based on receiving a user input for selecting a home appliance or piece of furniture in the three-dimensional map 10, the device 1000 may change a wall obscuring the selected home appliance or piece of furniture, from among an inner wall and an outer wall in the three-dimensional map 10, to be transparent, or may lower the height of the wall.

For example, as shown in FIG. 9, based on receiving a user input for selecting the air purifier image 30, the device 1000 may change all of the inner wall 15 obscuring the air purifier image 30, from among the inner wall and the outer wall in the three-dimensional map 10, to be transparent.

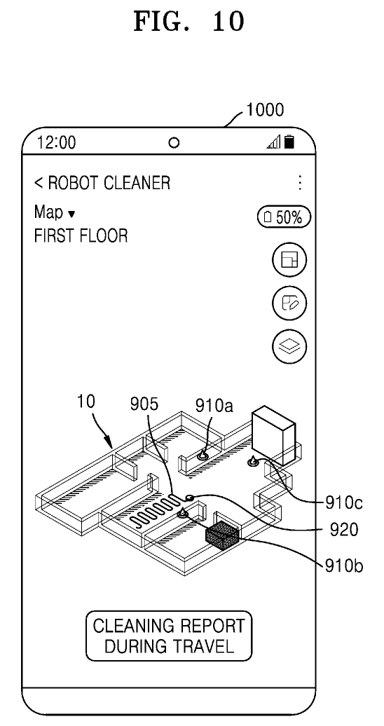

FIG. 10 illustrates a method, performed by a device, of indicating, on a three-dimensional map, an obstacle detected during travel of the cleaning robot 2000, according to an embodiment of the disclosure.

Referring to FIG. 10, the device 1000 may display an obstacle detected during travel of the cleaning robot 2000 on the three-dimensional map, and may increase the opacity of a wall such that the obstacle is not obscured by the wall.

The obstacle may include a person, a cup, animal excrement, a towel, clothing, and a wire, but is not limited thereto.

The device 1000 may receive, from the server 3000, information about obstacle detected during travel of the cleaning robot 2000. For example, when the cleaning robot 2000 detects an obstacle while traveling, the device 1000 may receive a push notification indicating the location of the obstacle from the cleaning robot 2000 through the server 3000. Also, for example, after the cleaning robot 2000 finishes cleaning, the device 1000 may receive a cleaning report indicating the location of the obstacle from the cleaning robot 2000 through the server 3000.

The information about the obstacle may include location information of the obstacle, identification information of the obstacle, and travel path information of the cleaning robot 2000, but is not limited thereto.

As shown in FIG. 10, the device 1000 may display images 910a, 910b, and 910c indicating obstacles at the locations of the obstacles on the three-dimensional map, based on location information of the obstacles. Although not shown in FIG. 10, the images 910a, 910b, and 910c indicating the obstacles may include identification information of the obstacles. The device 1000 may display an image 920 indicating the current location of the cleaning robot 2000 and an image 905 indicating the travel path of the cleaning robot 2000.

In this case, the device 1000 may display the image 910a, 910b, or 910c indicating the obstacle at the location of the obstacle on the three-dimensional map, and may display the wall to be transparent such that the image 910a, 910b, or 910c indicating the obstacle is not obscured by the wall. For example, the device 1000 may display a wall image having a predetermined opacity.

According to an embodiment of the disclosure, the device 1000 may increase the opacity of all of walls on the three-dimensional map when displaying the image 910a, 910b, or 910c indicating the obstacle.

According to an embodiment of the disclosure, the device 1000 may increase the opacity of a wall obscuring the image 910a, 910b, or 910c indicating the obstacle, from among the walls on the three-dimensional map.

Although not shown in FIG. 10, according to an embodiment of the disclosure, the device 1000 may display the image 910a, 910b, or 910c indicating the obstacle at the location of the obstacle on the three-dimensional map, and may lower the height of the wall to the floor such that the image 910a, 910b, or 910c indicating the obstacle is not obscured by the wall.

Although not shown in FIG. 10, according to an embodiment of the disclosure, the device 1000 may display an image indicating that an error has occurred at the location where the error has occurred in the cleaning robot 2000, and may increase the opacity of the wall such that the image indicating that an error has occurred is not obscured by the wall.

The error may include a situation where cleaning by the cleaning robot is stopped during travel. For example, the error may include a case where a sensor of the cleaning robot malfunctions, a case where a foreign substance becomes caught in a brush of the cleaning robot, a case where a dust bin of the cleaning robot is not properly mounted, a case where a battery of the cleaning robot is insufficient, or a case where the cleaning robot fails to find a room, home appliance, or piece of furniture designated as a cleaning spot, but is not limited thereto.

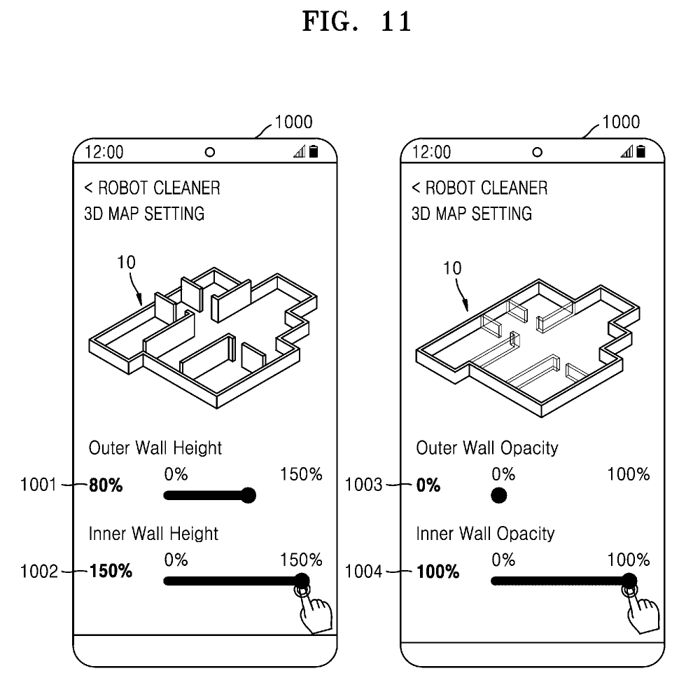

FIG. 11 illustrates a method, performed by a device, of obtaining a default value of a default value of a height of a wall or an opacity of a wall in a three-dimensional map, according to an embodiment of the disclosure.

Referring to FIG. 11, the device 1000 may provide a user interface for setting the default value of the height of the wall or the opacity of the wall in the three-dimensional map.

Referring to the left diagram of FIG. 11, the device 1000 may provide user interfaces 1001 and 1002 for setting a default value of the height of a wall in the three-dimensional map 10. The user interfaces 1001 and 1002 for setting the default value of the height of the wall may include the user interface 1001 for setting a default height of an outer wall and the user interface 1002 for setting a default height of an inner wall.

The device 1000 may receive a user input for setting the default height of the inner wall and the default height of the outer wall through the user interfaces 1001 and 1002 for setting the default value of the height of the wall.

For example, the device 1000 may receive a user input for reducing the outer wall to 80 % and increasing the inner wall to 150 %. Also, for example, the device may receive a user input for reducing the outer wall to 0 % and maintaining the inner wall at 100 %. Also, for example, the device may receive a user input for reducing the outer wall to 0 % and reducing the inner wall to 0 %. Also, when the height of the wall changes, the device 1000 may change the length of a shadow to correspond to the height of the wall.

Referring to the right diagram of FIG. 11, the device 1000 may provide user interfaces 1003 and 1004 for setting a default value of the opacity of the wall in the three-dimensional map. The user interfaces 1003 and 1004 for setting the default value of the opacity of the wall may include the user interface 1003 for setting a default opacity of the outer wall and the user interface 1004 for setting a default opacity of the inner wall.

The device 1000 may receive a user input for setting the default opacity of the inner wall and the default opacity of the outer wall through the user interfaces 1003 and 1004 for setting the default value of the opacity of the wall. For example, the device 1000 may receive a user input for setting the outer wall to be opaque and the inner wall to be 100 % transparent. Also, when the opacity of the wall changes, the device 1000 may change the darkness of a shadow to correspond to the opacity of the wall.

Based on a user account, the device 1000 may transmit, to the server 3000, the default height and the default opacity set by the user. The server 3000 may store the default height and the default opacity in correspondence with the user account. Also, when displaying the three-dimensional map, the device 1000 may receive information about the default height and the default opacity from the server 3000, and, based on the received information, may display a wall having the default height and the default opacity.

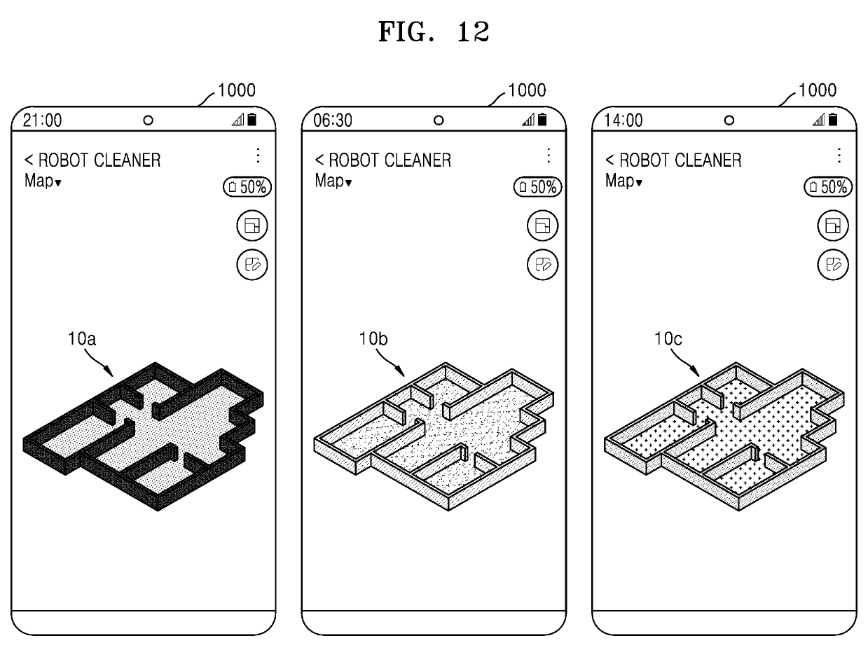

FIG. 12 illustrates a method, performed by a device, of indicating a current time of a cleaning robot on a three-dimensional map, according to an embodiment of the disclosure.

Referring to FIG. 12, the device 1000 may display the current time of the cleaning robot on the three-dimensional map by changing the colors of a wall and a floor of the three-dimensional map over time.

The device 1000 may determine the color of virtual lighting based on the current time of the location at which the cleaning robot is located and a global positioning system (GPS) value of the location at which the cleaning robot is located. The device 1000 may change the colors of the wall and the floor in the three-dimensional map based on the color of the virtual lighting.

The device 1000 may receive the current time and location information of the cleaning robot from the server 3000. The cleaning robot 2000 may obtain time information from a nearby peripheral device (e.g., a mobile device or a television (TV)), and may transmit the obtained time information to the server 3000. Also, the cleaning robot 2000 may obtain location information from the nearby peripheral device, and may transmit the obtained location information to the server 3000. Also, the cleaning robot 2000 may obtain physical activity information (e.g., a user's sleep information) from a user device, and may transmit the obtained physical activity information to the server 3000. The server 3000 may identify a user's lifestyle pattern based on the user's physical activity information.

Based on at least one of the current time and the location information of the cleaning robot, the device 1000 may determine the location of the sun in an area where the cleaning robot is located. Also, the device 1000 may determine the color of virtual lighting corresponding to the determined location of the sun. The device 1000 may change the colors of the wall and the floor in the three-dimensional map based on the color of the virtual lighting.

For example, referring to the first diagram of FIG. 12, when the current time of the cleaning robot is 9:00 PM, the device 1000 may change the wall of the three-dimensional map to black and the floor to mint, thereby increasing the color contrast between the wall and the floor. Accordingly, the device 1000 may intuitively indicate that the current time zone is night.

Also, for example, referring to the second diagram of FIG. 12, based on determining that sunrise is occurring in the area where the cleaning robot is currently located, the device 1000 may intuitively indicate that the current time zone is dawn by changing the wall of the three-dimensional map to white and the floor to light purple.

Also, for example, referring to the third diagram of FIG. 12, when the current time of the cleaning robot is 2:00 PM, the device 1000 may intuitively indicate that the current time zone is afternoon by changing the wall of the three-dimensional map to light yellow and the floor to light brown.

According to an embodiment of the disclosure, the device 1000 may change the colors of the wall and the floor in the three-dimensional map by considering the current time and location information of the cleaning robot as well as the lifestyle pattern. For example, even when the current time is 10:00 AM, based on determining that the user is sleeping, based on the lifestyle pattern, the device 1000 may darken the wall and the floor in the three-dimensional map.

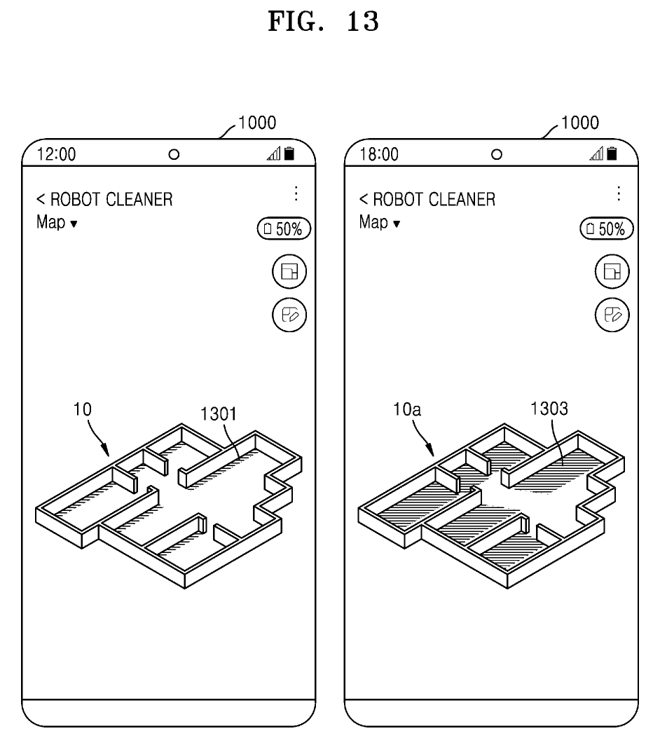

FIG. 13 illustrates a method, performed by a device, of indicating a current time of a cleaning robot on a three-dimensional map, according to an embodiment of the disclosure.

Referring to FIG. 13, the device 1000 may display the current time of the cleaning robot on the three-dimensional map by changing the length of a shadow of a wall in the three-dimensional map over time.

The device 1000 may receive the current time and location information of the cleaning robot from the server 3000. Based on the current time and the location information of the cleaning robot, the device 1000 may determine the location of the sun in an area where the cleaning robot is located. Also, the device 1000 may determine the location of virtual lighting corresponding to the determined location of the sun. Also, the device 1000 may change the length of the shadow of the wall in the three-dimensional map based on the location of the virtual lighting.

For example, when the current time zone is noon, the device 1000 may change the shadow of the wall to a short shadow 1301 corresponding to noon. Also, for example, when the current time zone is around 6:00 PM, the device 1000 may change the shadow of the wall to a long shadow 1303 corresponding to around 6:00 PM.

By changing the length of the shadow of the wall in the three-dimensional map, the device 1000 may intuitively display the current time in the area where the cleaning robot is located.

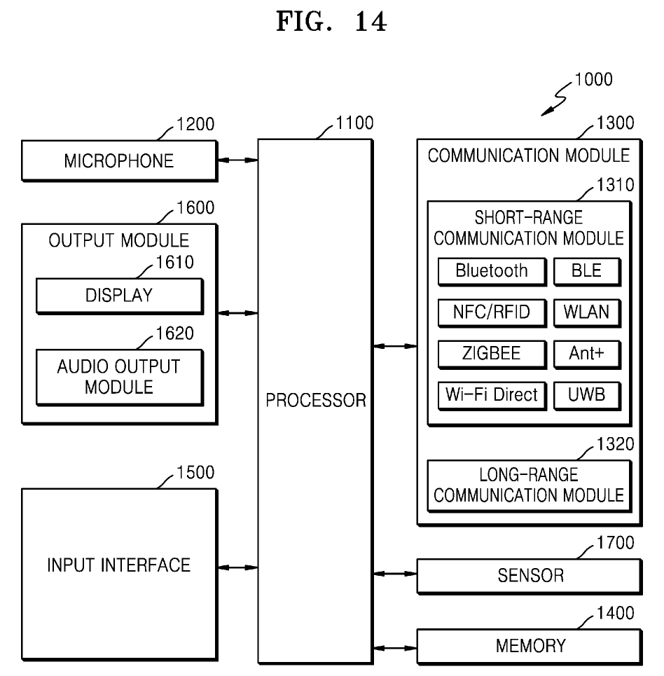

FIG. 14 illustrates a block diagram of a device, according to an embodiment of the disclosure.

Referring to FIG. 14, the device 1000 may include the processor 1100, a microphone 1200, the communication module 1300, the memory 1400, an input interface 1500, an output module 1600, and a sensor 1700.

Not all of the illustrated elements are essential elements of the device 1000. The device 1000 may be implemented by more elements than those illustrated in FIG. 14, or the device 1000 may be implemented by fewer elements than those illustrated in FIG. 14. For example, the device 1000 may be implemented by the processor 1100, the communication module 1300, the memory 1400, and the display 1610.

The processor 1100 controls the overall operation of the device 1000. The processor 1100 may control elements of the device 1000 by executing a program stored in the memory 1400.

According to an embodiment of the disclosure, the processor 1100 may include a separate NPU for performing an operation of a machine learning model. Also, the processor 1100 may include a central processing unit (CPU) or a graphics processing unit (GPU).

According to an embodiment of the disclosure, the processor 1100 may include a hardware structure (e.g., a neural processing unit) specialized for processing an artificial intelligence model. The artificial intelligence model may be generated through machine learning. Such learning may be performed, for example, in the device 1000 itself in which the artificial intelligence model is executed, or may be performed through the server 3000.

Examples of learning algorithms may include supervised learning, unsupervised learning, semi-supervised learning, or reinforcement learning, but are not limited to the aforementioned examples. The artificial intelligence model may additionally or alternatively include a software structure, in addition to a hardware structure.

The microphone 1200 may receive a user's voice command or voice request. Accordingly, the processor 1100 may control an operation corresponding to the voice command or voice request to be performed. Also, the microphone 1200 may receive sound in a vicinity of the device 1000.

The communication module 1300 may transmit and receive information, an image signal, or an audio signal according to a protocol with an external device (not shown) or the server 3000, under control by the processor 1100. The communication module 1300 may include at least one communication module and at least one port for transmitting and receiving data with the external device (not shown) or the server 3000.

Also, the communication module 1300 may communicate with the external device through at least one wired or wireless communication network. The communication module 1300 may include at least one of a short-range communication module 1310 or a long-range communication module 1320, or a combination thereof. The communication module 1300 may include at least one antenna for wirelessly communicating with another device.

The short-range communication module 1310 may include at least one communication module (not shown) for performing communication according to a communication standard, such as Bluetooth, Wi-Fi, Bluetooth low energy (BLE), NFC/RFID, Wi-Fi Direct, UWB, or ZIGBEE. Also, the long-range communication module 1320 may include a communication module (not shown) for performing communication through a network for Internet communication. In addition, the long-range communication module 1320 may include a mobile communicator for performing communication according to a communication standard, such as 3G, 4G, 5G, and/or 6G.

In addition, the communication module 1300 may include a communication module capable of receiving a control command from a remote controller (not shown) located at a close distance, for example, an infrared (IR) communication module.

The memory 1400 stores various information, data, instructions, and programs required for an operation of the device 1000. The memory 1400 may include at least one of volatile memory or non-volatile memory, or a combination thereof. The memory 1400 may include at least one type of storage medium among flash memory type, hard disk type, multimedia card micro type, card type memory (e.g., secure digital (SD) or extreme digital (XD) memory), random access memory (RAM), static random access memory (SRAM), read-only memory (ROM), electrically erasable programmable read-only memory (EEPROM), programmable read-only memory (PROM), magnetic memory, a magnetic disk, and an optical disk. Also, the device 1000 may operate a web storage or cloud server for performing a storage function on the Internet.

The sensor 1700 may detect movement of the device 1000.

The sensor 1700 may include at least one of an acceleration sensor, a gyro sensor, a magnetometer sensor, a compass, a GPS, and a proximity sensor, but is not limited thereto.

The output module 1600 may include the display 1610 and an audio output module 1620, but is not limited thereto.

The display 1610 may output image data processed by an image processing unit (not shown) through a display panel (not shown), under control by the processor 1100. The display panel (not shown) may include at least one of a liquid crystal display, a thin film transistor-liquid crystal display, an organic light-emitting diode, a flexible display, a three-dimensional (3D) display, or an electrophoretic display.

The audio output module 1620 may output an audio signal to the outside of the device 1000. The audio output module 1620 may include, for example, a speaker or a receiver. The speaker may be used for a general purpose, such as multimedia playback or recording playback. The receiver may be used to receive an incoming call.

The input interface 1500 may receive a user input for controlling the device 1000. The input interface 1500 may include keys (not shown) and a touch screen (not shown). The input interface 1500 receives a user input and transmits the same to the processor 1100.

The input interface 1500 may include a user input device 1000 including a touch panel for detecting a user's touch, a button for receiving a user's push operation, a wheel for receiving a user's rotation operation, a keyboard, and a dome switch, but is not limited thereto.

Also, the input interface 1500 may include a motion detection sensor (not shown). For example, the motion detection sensor (not shown) may detect movement of the device 1000, and may receive the detected movement as a user input.

At least one processor 1100 may display, through the display 1610, a three-dimensional map indicating a cleaning space where the cleaning robot 2000 is located.

The at least one processor 1100 may receive, through the input interface 1500, a user input for selecting an area obscured by a wall as a cleaning area of the cleaning robot 2000. Also, based on the received user input, at least one processor 1100 may change the wall such that the selected area becomes visible.

The at least one processor 1100 may transmit, through the communication module 1300, location information of the selected area and information about a cleaning function set for the selected area to the cleaning robot 2000 through the server 3000.

The at least one processor 1100 may lower the height of the wall such that an object obscured by the wall becomes visible. The at least one processor 1100 may increase the opacity of the wall such that the object obscured by the wall becomes visible.

Based on receiving, through the input interface 1500, a user input for selecting a menu for setting a cleaning spot, the at least one processor 1100 may change the wall such that the object becomes visible.

Based on receiving, through the input interface 1500, a user input for selecting the object, the at least one processor 1100 may change the wall such that the object becomes visible.

Based on receiving, through the input interface 1500, a user input for adjusting the height or opacity of an inner wall or outer wall in the three-dimensional map, the at least one processor 1100 may individually adjust the inner wall or outer wall.

The at least one processor 1100 may display the three-dimensional map including an obstacle detected during travel of the cleaning robot 2000. In this case, the at least one processor 1100 may increase the opacity of a wall obscuring the obstacle to accurately indicate the location of the obstacle.

The at least one processor 1100 may receive, through the input interface 1500, a user input for setting a default value of at least one of the height of the wall or the opacity of the wall. Also, the at least one processor 1100 may display, through the display 1610, the three-dimensional map based on at least one default value.

The at least one processor 1100 may indicate a current time on the three-dimensional map by changing the color of at least one of the wall or a floor of the three-dimensional map over time.

The at least one processor 1100 may display the current time on the three-dimensional map by changing the length of a shadow of the wall of the three-dimensional map over time.

A machine-readable storage medium may be provided in the form of a non-transitory storage medium. Here, the "non-transitory storage medium" refers to a tangible device and does not include a signal (e.g., an electromagnetic wave), and this term does not distinguish between a case where data is stored in the storage medium semi-permanently and a case where data is stored in the storage medium temporarily. For example, the "non-transitory storage medium" may include a buffer in which data is temporarily stored.

According to an embodiment of the disclosure, the method according to various embodiments disclosed herein may be included in a computer program product and then provided. The computer program product may be traded as a product between a seller and a buyer. The computer program product may be distributed in the form of a machine-readable storage medium (e.g., compact disc read only memory (CD-ROM), or may be distributed online (e.g., downloaded or uploaded) through an application store or directly between two user devices (e.g., smartphones). In the case of online distribution, at least a portion of the computer program product (e.g., a downloadable application) may be temporarily stored in a machine-readable storage medium, such as memory of a manufacturer's server, an application store's server, or a relay server, or may be temporarily generated.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method of any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A device for providing a map of a cleaning area of a cleaning robot, the device comprising:
a display;
a communication module;
at least one memory, comprising one or more storage media, storing one or more instructions; and
at least one processor,
wherein the instructions, when executed by the at least one processor individually or collectively, cause the device to:
display, through the display, a three-dimensional map including a wall and an object of a cleaning space where the cleaning robot is located,
based on receiving a user input for selecting the object obscured by the wall as the cleaning area of the cleaning robot, change the wall such that the object becomes visible, and
transmit, to the cleaning robot, through the communication module, location information of the object and information about a cleaning function set for the object.

2. The device of claim 1, wherein the instructions, when executed by the at least one processor individually or collectively, further cause the device to lower a height of the wall such that the object obscured by the wall becomes visible.

3. The device of claim 2, wherein the instructions, when executed by the at least one processor individually or collectively, further cause the device to increase an opacity of the wall such that the object obscured by the wall becomes visible.

4. The device of claim 3, wherein the instructions, when executed by the at least one processor individually or collectively, further cause the device to, based on receiving a user input for selecting a menu for setting a cleaning spot, change at least one of the height of the wall or the opacity of the wall such that the object becomes visible.

5. The device of claim 1, wherein the instructions, when executed by the at least one processor individually or collectively, further cause the device to, based on receiving a user input for selecting the object, change the wall such that the object becomes visible.

6. The device of claim 2, wherein the instructions, when executed by the at least one processor individually or collectively, further cause the device to change the height or opacity of the wall obscuring the object, from among an inner wall and an outer wall in the three-dimensional map.

7. The device of claim 3, wherein the instructions, when executed by the at least one processor individually or collectively, further cause the device to:
display the three-dimensional map including an obstacle detected during travel of the cleaning robot, and
indicate a location of the obstacle by increasing the opacity of the wall obscuring the obstacle.

8. The device of claim 3, wherein the instructions, when executed by the at least one processor individually or collectively, further cause the device to:
receive a user input for setting a default value of at least one of the height of the wall or the opacity of the wall, and
display the three-dimensional map based on the at least one default value.

9. The device of claim 1, wherein the instructions, when executed by the at least one processor individually or collectively, further cause the device to indicate a current time of the cleaning robot on the three-dimensional map by changing a color of at least one of the wall or a floor of the three-dimensional map over time.

10. The device of claim 9, wherein the instructions, when executed by the at least one processor individually or collectively, further cause the device to indicate the current time of the cleaning robot on the three-dimensional map by changing a length of a shadow of the wall of the three-dimensional map over time.

11. A method, performed by a device, of providing a map of a cleaning area of a cleaning robot, the method comprising:
displaying a three-dimensional map including a wall and an object of a cleaning space where the cleaning robot is located;
based on receiving a user input for selecting the object obscured by the wall as the cleaning area of the cleaning robot, changing the wall such that the object becomes visible; and
transmitting, to the cleaning robot, location information of the object and information about a cleaning function set for the object.

12. The method of claim 11, wherein the changing of the wall such that the object becomes visible comprises lowering a height of the wall such that the object obscured by the wall becomes visible.

13. The method of claim 12, wherein the changing of the wall such that the object becomes visible comprises increasing an opacity of the wall such that the object obscured by the wall becomes visible.

14. The method of claim 13, wherein the changing of the wall such that the object becomes visible, based on receiving the user input for selecting the object obscured by the wall as the cleaning area of the cleaning robot, comprises, based on receiving a user input for selecting a menu for setting a cleaning spot, changing at least one of the height of the wall or the opacity of the wall such that the object becomes visible.

15. The method of claim 11, wherein the changing of the wall such that the object becomes visible, based on receiving the user input for selecting the object obscured by the wall as the cleaning area of the cleaning robot, comprises, based on receiving a user input for selecting the object, changing the wall such that the object becomes visible.

16. The method of claim 13, further comprising:
changing the height or opacity of the wall obscuring the object, from among an inner wall and an outer wall in the three-dimensional map.

17. The method of claim 13, further comprising:
displaying the three-dimensional map including an obstacle detected during travel of the cleaning robot; and
indicating a location of the obstacle by increasing the opacity of the wall obscuring the obstacle.

18. The method of claim 13, further comprising:
receiving a user input for setting a default value of at least one of the height of the wall or the opacity of the wall; and
displaying the three-dimensional map based on the at least one default value.

19. One or more non-transitory computer-readable storage media storing one or more computer programs including computer-executable instruction that, when executed by one or more processors of a device, of providing a map of a cleaning area of a cleaning robot, individually or collectively, cause the device to perform operations, the operations comprising:
displaying a three-dimensional map including a wall and an object of a cleaning space where the cleaning robot is located;
based on receiving a user input for selecting the object obscured by the wall as the cleaning area of the cleaning robot, changing the wall such that the object becomes visible; and
transmitting, to the cleaning robot, location information of the object and information about a cleaning function set for the object.

20. The one or more non-transitory computer-readable storage media of claim 19, wherein the changing of the wall such that the object becomes visible comprises lowering a height of the wall such that the object obscured by the wall becomes visible.
